(19) United States
(12) Patent Application Publication
(10) Pub. No.: US 2018/0328645 A1
(43) Pub. Date: Nov. 15, 2018

(54) Apparatus for Cooling a Pressure Cooker Lid

(71) Applicant: Double Insight Inc., Ottawa (CA)

(72) Inventors: Jiwei R. Wang, Ottawa (CA); Yi Qin, Ottawa (CA); Dongjun Wang, Ottawa (CA)

(21) Appl. No.: 15/967,796

(22) Filed: May 1, 2018

(30) Foreign Application Priority Data
May 10, 2017 (CA) 2966271

(51) Int. Cl. F25D 19/00; A47J 27/09; A47J 36/06; F25D 3/02

(52) U.S. Cl. CPC F25D 19/00; A47J 27/09; F25D 2303/0844; F25D 3/02; A47J 36/06

(57) ABSTRACT

An apparatus for cooling a lid of an electric pressure cooker is provided. The apparatus comprises a sealed container sealing a coolant such as water. The container has a top wall, and a bottom wall for contacting an exterior surface of the lid. The bottom wall of the apparatus comprises material having a sufficiently high thermal conductivity. At least a portion of the bottom wall of the apparatus has a contour substantially matching a contour of at least a portion of the exterior surface of the lid of the electric pressure cooker. The apparatus may include friction, magnetic or fastening means for engaging with the electric pressure cooker or a part thereof.

### CROSS REFERENCE TO RELATED APPLICATIONS

This patent application is a non-provisional patent application of Canadian patent application 2,966,271 filed on May 10, 2017 and entitled “Apparatus for Cooling a Pressure Cooker Lid”, which is hereby incorporated by reference in its entirety.

### FIELD OF THE INVENTION

The present invention relates generally to apparatuses for cooling a cooking pot, and particularly to apparatuses for cooling the lid of a pressure cooker for the purposes of reducing the pressure inside the cooker and allowing the lid to be opened safely.

### BACKGROUND OF THE INVENTION

Electric pressure cookers are known for their fast cooking capability. However, there are problems associated with releasing the pressure during or after cooking. For example, the conventional method of running cold tap water over the lid of a stove top pressure cooker (i.e., non-electric cooker) generally cannot be applied to an electric pressure cooker because doing so may permanently damage the electronic components, printed circuit boards, and/or other parts of the electric pressure cooker. In addition, the natural release method, wherein the pressure cooker is removed from heat source to allow the pressure to drop naturally, is very time consuming and may take about 30˜50 minutes or more depending on the volume of the food being cooked. Furthermore, the method of operating a pressure-release valve on the lid to reduce pressure cannot be applied to certain food items, e.g. porridge, legumes, soup, or other liquid food, because hot steam/liquid may be discharged at high pressure from the valve and can cause serious injuries to the user.

Some of the prior art electric pressure cookers adopted a cooling mechanism that requires the provision of a water chamber located inside the lid of the electric pressure cooker, wherein the water chamber is in fluid communication with a water inlet disposed on top of the lid for injecting water into the chamber, and a water outlet for discharging the water after the injected water has circulated within the water chamber. Such solution is structurally complicated, cumbersome to operate, costly, and still unsafe due to the required water circulation within the cooker.

Therefore, there remains a need for improved devices and methods for cooling electric pressure cookers.

### SUMMARY OF THE INVENTION

It is an object of the present invention to provide a device and method for quickly and safely cooling down an electric pressure cooker.

In accordance with one aspect of the present invention, there is provided an apparatus for cooling a lid of an electric pressure cooker, comprising: a sealed container sealing a coolant therein, the container comprising a top wall, and a bottom wall for contacting an exterior surface of the lid, the bottom wall comprising material having a sufficiently high thermal conductivity; wherein at least a portion of the bottom wall has a contour substantially matching a contour of at least a portion of the exterior surface of the lid.

In accordance with another aspect of the present invention, there is provided an apparatus for cooling a curved lid of an electric pressure cooker, comprising: a sealed container having a coolant sealed therein, the container comprising a top wall, and a bottom wall for contacting an exterior surface of the curved lid, the bottom wall comprising material having a sufficiently high thermal conductivity; wherein at least a portion of the bottom wall has a curvature substantially matching a curvature of at least a portion of the exterior surface of the curved lid.

In accordance with another aspect of the present invention, there is provided a kit assembly for cooling a lid of an electric pressure cooker, comprising: a first member comprising a sealed container sealing a coolant therein, the sealed container comprising a top wall, and a bottom wall for contacting an exterior surface of the lid, the bottom wall comprising material having a sufficiently high thermal conductivity, at least a portion of the bottom wall having a contour substantially matching a contour of at least a portion of the exterior surface of the lid, the bottom wall comprising at least one recess; and a second member comprising at least one pad removably receivable by the at least one recess of the bottom wall.

In accordance with another aspect of the present invention, there is provided a kit assembly for cooling a lid of an electric pressure cooker, comprising: a first member comprising a sealed container sealing a coolant therein, the sealed container comprising a top wall, a bottom wall for contacting an exterior surface of the lid, and a magnetic material at least partially disposed on or embedded in at least a part of the sealed container, the bottom wall comprising material having a sufficiently high thermal conductivity, at least a portion of the bottom wall having a contour substantially matching a contour of at least a portion of the exterior surface of the lid; and a second member constructed and arranged to magnetically engage with the sealed container.

Other features and advantages of the present invention will become apparent from the following detailed description and the accompanying drawings, which illustrate, by way of example, the principles of the invention.

### BRIEF DESCRIPTION OF THE DRAWINGS

By way of example only, preferred embodiments of the present invention are described hereinafter with reference to the accompanying drawings, wherein:

FIG. 1 shows a perspective top view of an apparatus in accordance with an example embodiment of the present disclosure;

FIG. 2 shows a perspective bottom view of an apparatus in accordance with an example embodiment of the present disclosure;

FIGS. 2(a)-2(f) are schematic representations of cross sectional views illustrating the apparatus of FIG. 1 and variations thereof in accordance with example embodiments of the present disclosure;

FIG. 3 is a partial perspective view illustrating the apparatus of FIG. 1 placed on top of a lid of an electric pressure cooker in accordance with example embodiments of the present disclosure; and

FIG. 4 is a schematic representation of a partial cross sectional view taken along line A-A of FIG. 3 illustrating the apparatus of FIG. 1 placed on top of a lid of an electric pressure cooker in accordance with example embodiments of the present disclosure.

### DETAILED DESCRIPTION OF THE INVENTION

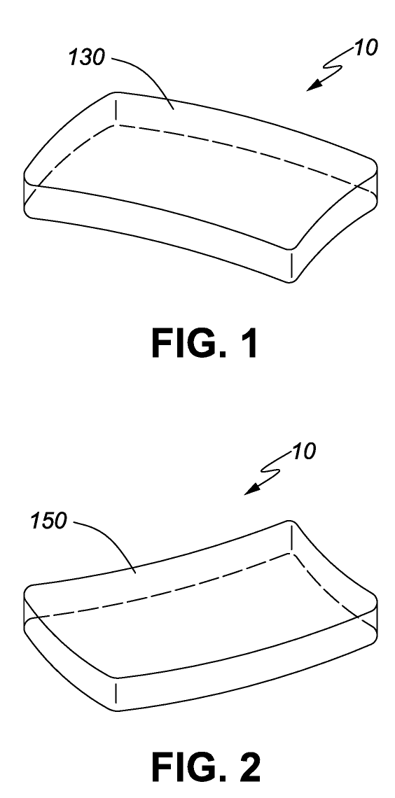

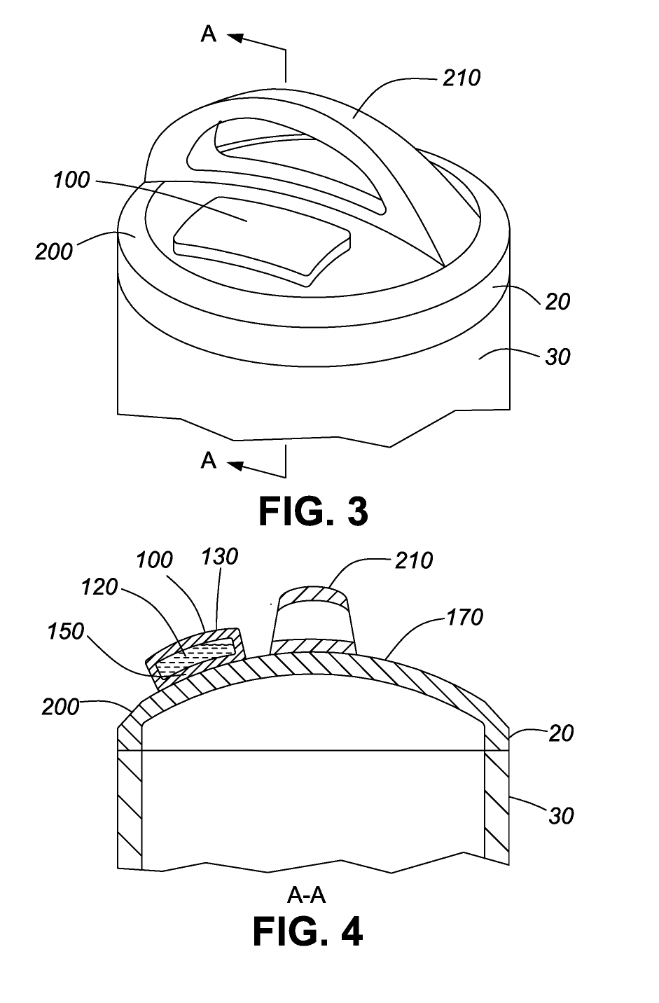

Referring to FIGS. 1-4, an exemplary embodiment of the present invention is illustrated as apparatus 10 for cooling a lid 20 of an electric pressure cooker 30. The lid 20 of the electric pressure cooker 30 preferably is substantially dome shaped. However, it is possible that in some embodiments, the lid 20 is configured to be substantially reverse dome shaped, or substantially flat. The electric pressure cooker 30 may comprise housing, power source, heating elements, cooking pot, controlling means, sensors, safety valve, and other components. These components may be incorporated into the electric pressure cooker 30 in manners known in the art, and will not be explicitly discussed in detail herein.

The apparatus 10 comprises a sealed container 100 having a coolant 120 sealed therein. The sealed container 100 can be constructed using suitable materials that can be formed or shaped, which may include rigid, flexible, and/or malleable materials. The coolant 120 can be any liquid or gel medium having high thermal capacity suitable for heat transfer. Preferably, the coolant 120 is water, which can be easily frozen into ice in a freezer or refrigerator and can then absorb a large amount of heat from the environment before warming above 0° C. The sealed container 100 is partially filled with coolant 120 to allow for the expansion of the coolant 120 when the coolant 120 is frozen within the sealed container 100.

The sealed container 100 comprises a top wall 130, and a bottom wall 150 for contacting an exterior surface 170 of the lid 20 when the apparatus 10 is placed thereon. The top wall 130 and/or the bottom wall 150 can be in any suitable shape, including square, rectangle, triangle, polygon, circular, oval, and other regular or irregular shapes.

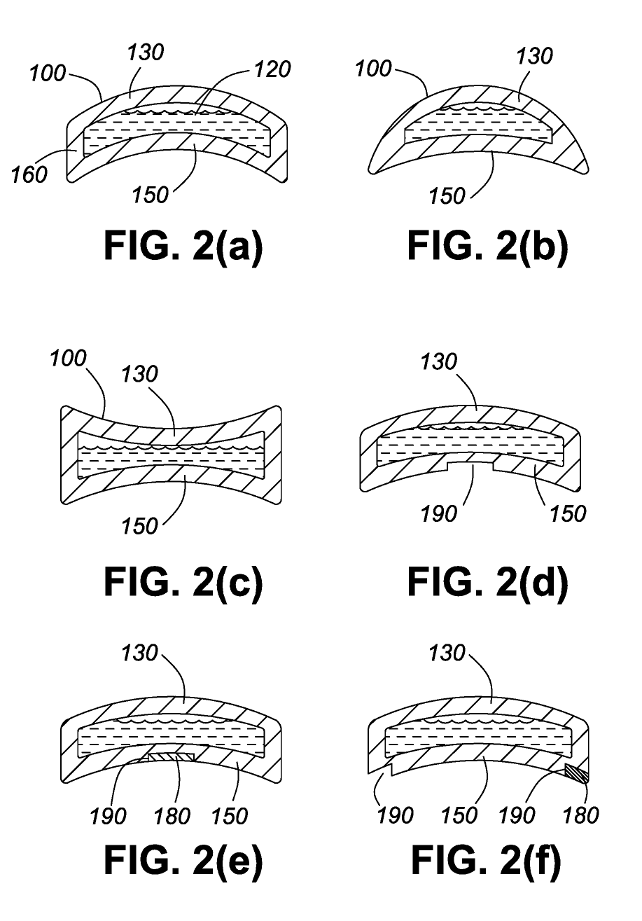

In some embodiments, as shown in FIGS. 2 (a), (c), (d), (e) and (f), the sealed container 100 comprises a periphery sidewall 160 extending between the top wall 130 and the bottom wall 150. However, the periphery sidewall 160 is optional, and in some embodiments, as seen in FIG. 2 (b), the top wall 130 tapers toward and merges with the bottom wall 150 without a periphery sidewall there between.

The bottom wall 150 comprises one or more materials having a sufficiently high thermal conductivity relative to plastic materials such as polyethylene, PVC, epoxy-based materials, and other similar materials. Preferably, the bottom wall 150 comprises at least one material having a thermal conductivity of about 30 W/(mK) or higher. More preferably, the bottom wall 150 comprises at least one material having a thermal conductivity of about 100 W/(mK) or higher. In some preferred embodiments, the bottom wall 150 comprises at least one metal or metal alloy based material, such as aluminum, copper, brass, aluminum brass, zinc, and/or alloy of one or more of the above. In some embodiments, the bottom wall 150 can comprise or be made of crystalline ultrahigh molecular weight polyethylene (UHMWPE) or molecular-aligned UHMWPE based materials or composites, which can be made to have significantly higher thermal conductivity than that of traditional plastic materials or polymers. In some other embodiments, the bottom wall 150 comprises polymer composite wherein particles or fibers with higher thermal conductivity, such as metals, ceramics, graphene, or carbon nanotube, are incorporated or introduced into the polymer matrix, so that the bottom wall 150 has a sufficiently high thermal conductivity relative to plastic materials or polymers. Advantageously, the use of the aforementioned materials allows the bottom wall 150 to be constructed rigidly enough to retain its shape and form after the coolant 120 is frozen within the sealed container 100.

The bottom wall 150 is constructed and arranged so that at least a portion of the bottom wall 150 has a contour substantially matching a contour of at least a portion of an exterior surface 170 of the lid 20.

In some embodiments, as shown in FIGS. 1-4, where the lid 20 has a curved, dome shaped configuration, and its exterior surface 170 is substantially a convex curved surface, the bottom wall 150 or at least a portion thereof is constructed to have a curvature substantially matching the curvature of a portion of the exterior surface 170 of the lid 20. Similarly, in some embodiments where the lid 20 has a reverse dome shaped (i.e., concave) configuration, the bottom wall 150 or a portion thereof can be constructed to have a concave curvature substantially matching the curvature of a portion of the exterior surface 170 of the lid 20. In some embodiments, the exterior surface 170 of the lid 20 can be made substantially flat or have a curvature of zero. In such case, the bottom wall 150 or a portion thereof is constructed to have a substantially flat contour so as to match the curvature of a corresponding portion of the exterior surface 170 of the lid 20.

The top wall 130, and the periphery sidewall 160, where applicable, may be constructed with the same material as that of the bottom wall 150. Alternatively, the top wall 130 and/or any periphery sidewall 160 may be made of materials that are different from that of the bottom wall 150. For example, in some embodiments, the bottom wall 150 is made of a metal or alloy, such as copper, aluminum, or brass, while the top wall 130 is made of plastic to reduce the overall weight of the apparatus 10 and provide comfort and warmth to a user's hand.

The top wall 130 may take any suitable shape and/or form. In some embodiments, as shown in FIG. 2 (a), the top wall 130 may have a shape and form that is substantially identical or similar to that of the bottom wall 150. In some embodiments, as shown in FIG. 2 (c), the top wall 130 is configured and constructed in such a way that the apparatus 10 can be placed on top of the lid 20 by either the top wall 130 or the bottom wall 150, while ensuring that the contact surface of the apparatus 10 substantially conforms to at least a portion of the exterior surface of the lid 20. In such embodiments, preferably the top wall 130 comprises at least one material having a sufficiently high thermal conductivity similar to that of the bottom wall 150, so that the apparatus 10 can be used symmetrically with respect to the top wall 130 and the bottom wall 150. In some embodiments, the distance between an interior surface of the top wall 130 and an interior surface of the bottom wall 150 may vary along a length of the apparatus 10. In some embodiments, the distance between an exterior surface of the top wall 130 and an exterior surface of the bottom wall 150 may vary along a length of the apparatus 10. In some embodiments, the top wall 130 and the bottom wall 150 have varying interior and exterior distances therebetween along a length of the apparatus 10. In some embodiments, the top wall 130 and the bottom wall 150 have substantially uniform interior and/or exterior distances there between along a length of the apparatus 10.

In operation, the apparatus 10 is first placed into a freezer to freeze the coolant sealed therein. Then the apparatus 10 is placed on top of the lid 20 of the electric pressure cooker 30, with the bottom wall 150 contacting the top surface 170 of the lid 20, so that the contour or curvature of at least a portion of the bottom wall 150 substantially matches the contour or curvature of at least a portion of the exterior surface 170 of the lid 20.

Advantageously, the apparatus 10, with frozen coolant 120 sealed therein and at least one contact surface of high thermal conductivity and shaped to substantially conform to the contour of at least a portion of the top surface 170 of the lid 20 of the electric pressure cooker 30, can quickly and safely absorb a large amount of heat from the lid 20 when placed thereon during or after cooking. The substantial conformity between a contact surface of the apparatus 10 and the top surface 170 of the lid 20 not only maximizes the area of heat absorption/exchange, but also maximizes the friction between the contacting surfaces. It has been observed that by using the apparatus 10 disclosed herein, the pressure release time can be reduced to about 5 minutes for certain types of cooking, which is a significant reduction from natural release method. Furthermore, unlike prior art solutions implemented on the electric pressure cookers, the apparatus 10 does not require change or modification to the pressure cooker, does not require water supply and/or circulation, and is convenient and quick to deploy as the cooling needs arise.

The apparatus 10 can engage with or be placed on the lid 20 in a number of ways.

In some embodiments, the apparatus 10 can be configured and constructed for placement on the lid 20 by way of friction between the bottom wall 150 and the surface 170. In some embodiments, the weight and/or volume distribution of the sealed container 100 can be configured to have imbalance in favor of one portion of the sealed container 100 over another portion thereof, thereby enhancing the overall balance of the sealed container 100 against a curved or slightly sloped surface 170.

In some embodiments, as shown in FIGS. 2 (e) and 2 (f), the bottom wall 150 of the apparatus 10 is provided with at least one pad or strip 180 for enhancing the friction with the exterior surface 170 of the lid 20. As an example, the at least one friction pad 180 may be received in a corresponding recess, cavity, or channel 190 provided on the bottom wall 150 and be arranged to be substantially flush with the exterior surface of the bottom wall 150. The at least one friction pad 180 may be permanently or removably attached to or received in the recess, cavity, or channel 190. The at least one friction pad 180 can be made of any suitable materials, including plastic, rubber, silica gel, resins, metals, sintered friction materials, and other friction material known in the art. In some embodiments, as shown in FIG. 2 (d), the bottom wall 150 comprises at least one recess, cavity, or channel 190 without a friction pad 180 received therein. In such case, at least one projection, protrusion, or adhesive strip can be provided or disposed on the surface 170 of the lid 20 to match with or be received by the at least one recess, cavity, or channel 190 provided on the bottom wall 150, so that the apparatus 10 can be mounted on the lid 20 by way of one or more recesses and corresponding projections. In some embodiments, the at least one matching projection, protrusion, or strip 180 forms a part of the surface 170 of the lid 20. For example, in some embodiments, the at least one matching projection, protrusion, or strip 180 may be permanently or removably attached to or mounted on the lid 20 or a part thereof, or can be integrally constructed as a part of the lid 20. In some embodiments, the at least one pad or strip 180 received in the corresponding recess or channel 190 comprises adhesive material or substance for enhancing the friction with the exterior surface 170 of the lid 20. In some embodiments, the above noted at least one recess 190 and/or pad 180 is located near a corner or periphery of the bottom wall 150, or formed between the periphery sidewall 160, where applicable, and the bottom wall 150, or formed between the top wall 130 and the bottom wall 150. In essence, the recess 190 and/or pad 180 can be provided at any suitable part of the bottom wall 150.

In some embodiments, the apparatus 10 can be placed on the lid surface 170 while being further supported by another part of the lid 20. For example, the apparatus 10 can be placed on the exterior surface 170 of the lid 20 against a periphery rim 200 of the lid 20 or a portion of the periphery rim 200. In some embodiments, magnetic materials can be permanently or removably attached to or embedded in the apparatus 10 and a part of the lid 20, respectively, to supplement the support for the apparatus 10. In some embodiments, the apparatus 10 further comprises fastening means, which includes but is not limited to fasteners, hooks, loops, strings, clips and other similar devices, for coupling to the lid 20 or a part thereof (e.g., lid handle 210).

The apparatus 10 described herein can be provided as a kit assembly for use with the electric pressure cooker 30. In some embodiments, the kit assembly includes a first member comprising the sealed container 100, wherein the bottom wall 150 of the sealed container 100 comprises at least one recess or channel 190, and a second member comprising at least one pad or strip 180 to be removably received by or matched with the at least one recess or channel 190. In some embodiments, the at least one pad or strip 180 is operable to be deployed or provided in the form of at least one projection, protrusion, or strip 180 permanently or removably attached to or mounted on the lid 20 or a part thereof, or integrally constructed as a part of the lid 20. In some embodiments, the at least one pad or strip 180 comprises adhesive material or substance for enhancing the friction between the bottom wall 150 and the exterior surface 170 of the lid 20. In some embodiments, the kit assembly includes a first member comprising the sealed container 100 having magnetic material disposed thereon or embedded therein, and a second member constructed and arranged to magnetically engage with the sealed container 100. In operation, the second member can be deployed on the lid 20 or a part thereof to magnetically engage with the sealed container 100 or a part thereof. In some embodiments, the second member is permanently or removably attached to or mounted on the lid 20 or a part thereof, or integrally constructed as a part of the lid 20 to magnetically engage with the sealed container 100. In some example embodiments, magnetic materials are disposed within at least one recess, cavity, or channel 190. In some embodiments, the kit assembly includes a first member comprising the sealed container 100, wherein the sealed container 100 has magnetic material disposed thereon or embedded therein, and the bottom wall 150 of the sealed container 100 comprises at least one recess or channel 190, a second member comprising at least one pad or strip 180 to be removably received by or matched with the at least one recess or channel 190, and a third member constructed and arranged to magnetically engage with the sealed container 100.

Although the present invention has been described in considerable detail with reference to certain preferred embodiments thereof, other embodiments and modifications are possible. Therefore, the scope of the appended claims should not be limited by the preferred embodiments set forth in the examples, but should be given the broadest interpretation consistent with the description as a whole.

1. An apparatus for cooling a lid of an electric pressure cooker, comprising:
a sealed container sealing a coolant therein, the container comprising a top wall, and a bottom wall for contacting an exterior surface of the lid, the bottom wall comprising material having a sufficiently high thermal conductivity; and
wherein at least a portion of the bottom wall has a contour substantially matching a contour of at least a portion of the exterior surface of the lid.

2. The apparatus of claim 1, wherein the lid is substantially dome shaped, and the bottom wall or at least a portion thereof is constructed to have a curvature substantially matching a curvature of a portion of the exterior surface of the lid.

3. The apparatus of claim 1, wherein the top wall comprises material having a sufficiently high thermal conductivity.

4. The apparatus of claim 1, wherein the top wall has a shape that is substantially identical or similar to that of the bottom wall.

5. The apparatus of claim 1, wherein the bottom wall comprises one or more metals.

6. The apparatus of claim 1, wherein the bottom wall comprises at least one recess.

7. The apparatus of claim 1, wherein the bottom wall comprises at least one pad for enhancing friction with the exterior surface of the lid.

8. The apparatus of claim 1, wherein the apparatus comprises magnetic means for engaging the lid or a part thereof.

9. The apparatus of claim 1, wherein the apparatus comprises fastening means for engaging the lid or a part thereof.

10. A kit assembly for cooling a lid of an electric pressure cooker, comprising:
a first member comprising a sealed container sealing a coolant therein, the sealed container comprising a top wall, and a bottom wall for contacting an exterior surface of the lid, the bottom wall comprising material having a sufficiently high thermal conductivity, at least a portion of the bottom wall having a contour substantially matching a contour of at least a portion of the exterior surface of the lid, the bottom wall comprising at least one recess; and
a second member comprising at least one pad removably receivable by the at least one recess of the bottom wall.

11. The kit assembly of claim 10, wherein the second member is operable to be deployed on the lid or a part thereof.

12. The kit assembly of claim 10, wherein the at least one pad is configured to be substantially flush with an exterior surface of the bottom wall when received by the at least one recess of the bottom wall.

13. A kit assembly for cooling a lid of an electric pressure cooker, comprising:
a first member comprising a sealed container sealing a coolant therein, the sealed container comprising a top wall, a bottom wall for contacting an exterior surface of the lid, and a magnetic material at least partially disposed on or embedded in at least a part of the sealed container, the bottom wall comprising material having a sufficiently high thermal conductivity,
at least a portion of the bottom wall having a contour substantially matching a contour of at least a portion of the exterior surface of the lid; and
a second member constructed and arranged to magnetically engage with the sealed container.

14. The kit assembly of claim 13, wherein the second member is operable to be deployed on the lid or a part thereof.
